(19) United States
(12) Patent Application Publication
(10) Pub. No.: US 2019/0082303 A1
(43) Pub. Date: Mar. 14, 2019

(54) Methods, Apparatuses and Computer Program Products for Content Distribution

(71) Applicant: Telefonaktiebolaget LM Ericsson (publ), Stockholm (SE)

(72) Inventors: Elena Fersman, Stockholm (SE); Craig Donovan, Bromma (SE); Hongxin Liang, Upplands Väsby (SE); Simon Moritz, Sollentuna (SE); Vlasios Tsiatsis, Solna (SE)

(21) Appl. No.: 16/079,274

(22) PCT Filed: Mar. 18, 2016
(86) PCT No.: PCT/EP2016/055936

§ 371 Date: Aug. 23, 2018

(51) Int. Cl. H04W 4/06; H04L 29/06; H04W 4/02

(52) U.S. Cl. CPC H04W 4/06; H04L 65/4076; H04L 65/4084; H04W 4/025; H04L 65/1069

(57) ABSTRACT

A method (20) performed in a network node (9) for content distribution in a communication system (1) is disclosed. The method (20) comprises determining (21) a triggering criterion to be fulfilled; establishing (22) that there is common content in services requested by at least two communication devices (5a, 5b, 5c); and instructing (23) an access node (4a, 4b, 4c) of the communication system (1) to transmit the common content as one of: a multicast transmission and a broadcast transmission. A method (50) in a communication device (5a, 5b, 5c) and a method (80) in a network device (10) are also disclosed, as well as corresponding node, devices, computer programs and computer program products.

### TECHNICAL FIELD

The technology disclosed herein relates generally to the field of communication systems, and in particular to methods, network nodes, network devices, communication devices, computer programs and computer program products for content distribution in communication systems.

### BACKGROUND

An increasing number of different types of services are being provided to users of wireless communication devices such as, for instance, smart phones. The number of users is typically also high and still increasing. In densely populated areas, e.g. city areas, many users consume services such as music or video streaming, social networking applications, movie downloading etc. Consequently there is a high and increasing demand for resources in wireless communication systems. The amount of resources, in particular radio interface resources, is limited and this may constitute a limitation for operators of the wireless communication systems wanting to offer high quality services to their users, particularly in view of the increasing number of users and services.

### SUMMARY

An objective of the present invention is to address the above mentioned problem. An objective is to enable efficient usage of communication resources in a communication system.

The objective is according to an aspect achieved by a method performed in a network node for content distribution in a communication system. The method comprises determining a triggering criterion to be fulfilled; establishing that there is common content in services requested by at least two communication devices; and instructing an access node of the communication system to transmit the common content as one of: a multicast transmission and a broadcast transmission.

The method provides various advantages. For instance, the method enables an efficient usage of available bandwidth by using the same radio resources for common content. Further, by linking radio level efficiency mechanisms such as LTE-Broadcast/Multicast mechanisms with service-level information the resources usage is optimized at a system level. In accordance with the method the same content flow through the communication system only once, whereby an increased efficiency is obtained in the whole system. This is in contrast to the current method, wherein the same content flows through the communication system in multiple copies and may also be sent over the radio interface in multiple copies.

The objective is according to an aspect achieved by a computer program for a network node for distribution of content. The computer program comprises computer program code, which, when executed on at least one processor on the network node causes the network node to perform the method as above.

The objective is according to an aspect achieved by a computer program product comprising a computer program as above and a computer readable means on which the computer program is stored.

The objective is according to an aspect achieved by a network node for content distribution in a communication system. The network node is configured to: determine a triggering criterion to be fulfilled; establish that there is common content in services requested by at least two communication devices; and instruct an access node of the communication system to transmit the common content as one of: a multicast transmission and a broadcast transmission.

The objective is according to an aspect achieved by a method performed in a communication device for content reception in a communication system. The method comprises requesting a service from a network device; receiving, from an access node of the communication system, a multicast transmission and a unicast transmission, each comprising a respective content part of the requested service; and assembling the content of the multicast transmission and the content of the unicast transmission into the requested service.

The objective is according to an aspect achieved by a computer program for a communication device for content reception in a communication system. The computer program comprises computer program code, which, when executed on at least one processor on the communication device causes the communication device to perform the method as above.

The objective is according to an aspect achieved by a computer program product comprising a computer program as above and a computer readable means on which the computer program is stored.

The objective is according to an aspect achieved by a communication device for content reception in a communication system. The communication device is configured to: request a service from a network device; receive, from an access node of the communication system, a multicast transmission and a unicast transmission, each comprising a respective content part of the requested service; and assemble the content of the multicast transmission and the content of the unicast transmission into the requested service.

The objective is according to an aspect achieved by a method performed in a network device for content distribution in a communication system. The method comprises: establishing, based on information on location of at least two communication devices, that a proximity criterion is fulfilled; identifying that the at least two communication devices have common content in a respective requested service; and requesting a network node of the communication system to convey the identified common content to the at least two communication devices as one of: a multicast transmission and a broadcast transmission.

The objective is according to an aspect achieved by a computer program for a network device for content reception in a communication system. The computer program comprises computer program code, which, when executed on at least one processor on the network device causes the network device to perform the method as above.

The objective is according to an aspect achieved by a computer program product comprising a computer program as above and a computer readable means on which the computer program is stored.

Further features and advantages of the embodiments of the present invention will become clear upon reading the following description and the accompanying drawings.

### BRIEF DESCRIPTION OF THE DRAWINGS

FIG. 1 illustrates schematically an environment in which embodiments according to the present teachings may be implemented.

FIG. 2 shows the environment of FIG. 1, with some additional devices.

FIG. 3 is a sequence diagram showing various steps of embodiments according to the present teachings.

FIG. 4 illustrates a flow chart over steps of an embodiment of a method in a network node in accordance with the present teachings.

FIG. 5 illustrates schematically a network node and means for implementing embodiments of the method in accordance with the present teachings.

FIG. 6 illustrates a network node comprising function modules/software modules for implementing embodiments of the present teachings.

FIG. 7 illustrates a flow chart over steps of an embodiment of a method in a communication device in accordance with the present teachings.

FIG. 8 illustrates schematically a communication device and means for implementing embodiments of the method in accordance with the present teachings.

FIG. 9 illustrates a communication device comprising function modules/software modules for implementing embodiments of the present teachings.

FIG. 10 illustrates a flow chart over steps of an embodiment of a method in a network device in accordance with the present teachings.

FIG. 11 illustrates schematically a network device and means for implementing embodiments of the method in accordance with the present teachings.

FIG. 12 illustrates a network device comprising function modules/software modules for implementing embodiments of the present teachings.

### DETAILED DESCRIPTION

In the following description, for purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail. Same reference numerals refer to same or similar elements throughout the description.

The inventors of the present invention have identified a way of improving resource utilization in communication systems. It is a common situation that multiple users request same or similar content approximately simultaneously at the same or nearby locations. A particular example is multiple users listening to the same music, reading the same document or watching the same movie clip at almost the same time in the same part of e.g. a city, such as at a train station. Another example is multiple users consuming the same advertisements, in the form or text, audio and/or video, sent from a content provider to the users without the content provider being aware of the location proximity of the users. This results in a waste of radio and network resources since the same content is transmitted to multiple nearby users at the same time or almost at the same time using different radio and network resources.

A subset of these people may also be connected to the same radio access node (sometimes also denoted radio access point), e.g. base station, or to nearby radio access points of a wireless network through which the services are provided. However, this may be known by the operator of the wireless network, but not by the service provider if the latter is not also the operator of the wireless network. In an aspect of the present teachings, the operator of the wireless network may detect that many users within an area are requesting the same type of services (although the content may be encrypted). The operator may then provide, to a service provider providing the services, information about users that are using the same access node, and, for instance, suggest that multicasting is used for this content. In a situation wherein e.g. the radio resources are scarce it may be in the interest of the operator of the wireless network but also of the service provider to avoid interruptions in the service, in a mutual effort to keep the users satisfied.

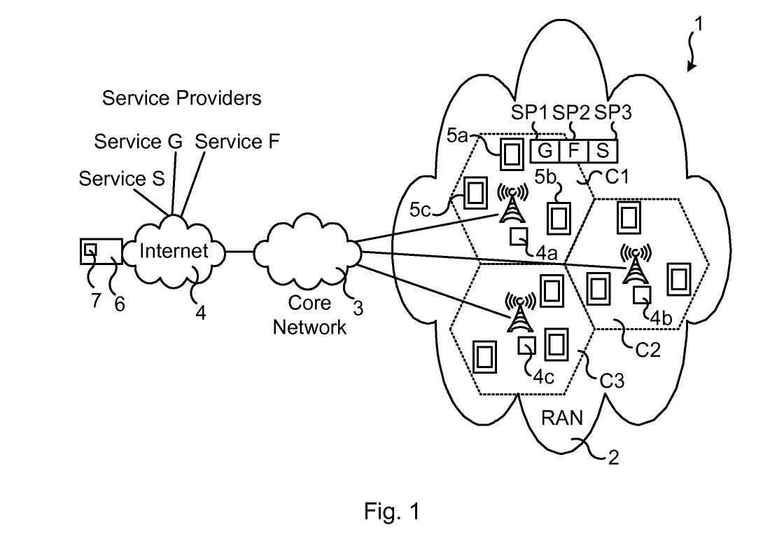

FIG. 1 illustrates schematically an environment in which embodiments according to the present teachings may be implemented. A communication system 1 comprises a wireless access network 2 and a core network 3. The wireless access network 2 may comprise a number of radio access nodes 4a, 4b, 4c, for which different denotations are used, e.g. base station, evolved NodeB or eNB to mention a few examples. The radio access nodes 4a, 4b, 4c serve users within respective one or more geographical areas, often denoted cells C1, C2, C3. The radio access node 4a, 4b, 4c each communicates wirelessly with communication devices 5a, 5b, 5c (in the following exemplified by user equipment, UE) residing within their respective coverage area.

The core network 3 comprises various network nodes, which nodes may also be denoted in different ways depending e.g. on communication system at hand. In Long Term Evolution (LTE), for instance, the core network 3 may comprise entities such as a Mobility Management Entity (MME) and packet data network gateways (PDN GW) providing connectivity to e.g. a packet data network (PDN) 4, e.g. Internet.

The communication system 1 may comprise or be connectable to the PDN 4. The PDN 4 in turn may comprise a server or cluster of servers, e.g. a server of the Internet (“web-server”) or any application server. Such server 6 may run various applications 7, providing services to the users of the UEs 5a, 5b, 5c. It is noted that some embodiments according to the present teachings may be implemented in a distributed manner, wherein different steps are performed by different entities, and may be implemented locally and/or in a centralized component (e.g. in a so called cloud environment). The network node in which a method according to the teachings may be implemented may comprise a server or other entity on the Internet e.g. according to a cloud computing model.

In FIG. 1, a system setup is shown wherein a first UE 5a has multiple service preferences SP1, SP2, SP3 for different services (indicated by G, F, S) stored therein (or remotely). The service providers of each respective service G, F, S are assumed to (also) store the user preferences SP1, SP2, SP3 for the services. Examples of such user preferences comprise user interface setup, playlists, web site favorites etc. The user preferences may be stored e.g. on a cloud platform of each respective service or on a UE application. For example, a service such as a search engine (denoted G in the FIG. 1) stores a list of features for each user for use in targeted advertisement, a social networking application (denoted F in the FIG. 1) stores the user preferences in terms of displayed widgets, embedded videos, user profile area (often also denoted “wall”) etc., and a music streaming service (denoted S in FIG. 1) may store user preferences such as genre preferences and playlists, etc.

When the same content is requested to be transmitted at the same time or almost at the same time towards multiple UEs 5a, 5b, 5c from the same radio access node 4a, 4b, 4c or two or more nearby radio access nodes, the radio bandwidth is used inefficiently by transmitting the same data, i.e. same bits of information, in separate channels. This problem is particularly heightened when the radio access node 4a, 4b, 4c are already heavily loaded. Radio access node caching content locally may improve on this problem, at least partially, from the service provider, more specifically from the PDN 4 to the radio access node 4a, 4b, 4c. However, this is not the case in the next link, i.e. from the radio access nodes 4a, 4b, 4c to UEs 5a, 5b, 5c, wherein the same bits of information are sent individually to each UE, using respective radio resources.

In the present description “similar content” is to be interpreted as meaning one of two things:

Category 1) similar audio, video, image content, advertisements etc. (which comprises audio, video, image, text, etc.) that the users have indicated they like or prefer based on user preferences, and

Category 2) the same content requested to be consumed at the same time or close in time, wherein the content is part of e.g. playlists or a standalone (single) piece of content.

For example, users that listen to songs from a music streaming service S and have indicated that they like Rock music from a particular band (i.e. music preferences) fall into category 1 above. Users that listen to the music streaming service S and have e.g. 2 songs in common in their current playlists fall into the category 2 above. Category 2 also comprises users that simultaneously use applications (e.g. smart phone applications) that receive e.g. the same advertisements over application advertisement channels.

Briefly, methods provided, in various embodiments, are based on using broadcasting and/or multicasting technology. In various such embodiments LTE Broadcast/Multicast technology is used for exemplifying and describing the embodiments, but it is noted that the methods are not restricted thereto, and are applicable also to future generation radio technologies, such as 5G. These embodiments then require that each UE 5a, 5b, 5c has means, e.g. a broadcast/multicast application, for receiving LTE Multicast packets. Further, there may also be a Service Provider application that suggests a core network node to use multicast/broadcast technology to transmit the common content, to thereby be able to push common content to the application on each UE 5a, 5b, 5c. The LTE Multicast/Broadcast technology is mainly used as a way of efficiently distributing e.g. TV or advertisements over the same radio access nodes 4a, 4b, 4c or nearby radio access nodes to UEs 5a, 5b, 5c that run the same broadcast/multicast application. Moreover LTE-Multicast/Broadcast is a feature that is specific for each mobile operator, in other words, whether the feature exists or is active is upon the discretion of the mobile operator. In the following, it is assumed that a single mobile operator supports the broadcast/multicast feature. However, it is noted that the solution may be implemented for multiple operators as well. The applicability of the present teachings on multiple operators may be limited to the core networks of the multiple operators. This since the radio networks of the different operators typically operate in separate radio frequencies, and e.g. multicasting would therefore not be applicable. As for the applicability of the present teachings in the core network, a particular example is given: consider, for instance, a first network operator A that has a business relationship with a service provider SP and business relationship with two other network operators B and C. The present teachings would allow the first operator A to send common content received by the SP through its core network to the core network of the other two operators B and C.

The disclosed solution takes advantage of service information such as similarity in content preferences or similarity of consumption applications on the UE 5a, 5b, 5c as well as physical proximity of users (e.g. user within a cell or within a cluster of nearby cells). One purpose is to enable an efficient usage of the bandwidth of the radio access network 2 and to avoid complete denial of service when the radio access network 2 e.g. is congested. The latter would be in the interest of the service provider as well, in order to keep their customers satisfied. Further, the service provider also benefits in that the demand for their services can be met in a more efficient way since the same content need not be sent separately to different users. The radio resource usage is reduced by using the same radio resources for the common content transmission.

Next, two situations are used as examples for describing aspects of the present teachings.

The first situation comprises users that would like to receive content based on playlists or a desired order of content consumption. Examples comprise users that subscribe to a specific service such as a social networking service, a music streaming service, a video service, etc., and they would like to consume similar content simultaneously, or nearly simultaneously, in the same cell C1 or nearby cells C1, C2, C3. Stated differently, the users request similar content simultaneously, or nearly simultaneously, within a certain geographical area. Another example is users of music or video services that have enabled an option for receiving arbitrary content from specific content sets e.g. from specific singers, directors, movie aficionados etc.

The second situation comprises users that in practice do not have control over their content consumption, i.e. content is pushed to them by a service provider. Content is typically pushed based on user-defined preferences or user profiles built by the service provider, e.g. through mining historical data about content consumption. An example is users in the same cell and nearby cells that use an application (which may be the same application or different applications on different UEs) that includes content pushing channels such as advertisement channels.

The solution, in different embodiments, for both cases utilizes for example LTE broadcast/multicast technology, and determines when to broadcast/multicast and to whom.

### Situation 1: Content Consumption of Overlapping Sets of Content

It is assumed that for each service there exists a set of content pieces, e.g. audio, video, text etc. It is further assumed that each user of such a service has access to an entire content collection, or a subset thereof, from the content/service provider depending on their respective service level agreement. In either case (access to a subset or the entire collection) it is assumed that each user has a set of e.g. playlists that refer to the actual allowed content which that user plays on demand. As an example on such referral, a playlist may state the title and the singer of a song, or a Universal Resource Identifier (URI) for the song. The playlists are ordered with a user-defined ordering, e.g. alphabetically based on title, and they have a consumption preference for the order, e.g. play-as-is mode or randomly/shuffle mode. A music streaming service may be such that a user may have multiple playlists with songs according to genre, user mood etc. Finally, it is also assumed that the content consumption on the UE 5a, 5b, 5c is done via an application, e.g. supplied by the service provider.

The solution is applicable, for instance, when users with overlapping playlists, i.e. different playlists that refer to at least one common content piece, consume the playlist content at the same time within the same cells or nearby cells. The playlists of the users with overlapping content pieces can be permanently or temporarily modified on the fly and the same content can be multicast to the applicable users at the same or close time instants. The modified playlist may, for instance, be valid while some conditions are fulfilled, e.g. a condition such as proximity of users. Moreover, the playlist of one user may be permanently or temporarily modified by adding new content that is already decided to fit the majority of the other users with similar preferences in the same or nearby cells, e.g. serving as a recommendation service for new content.

The individual and private content playlists may hence be permanently or temporarily modified or replaced with one or few playlists in common to all or a few sets of UEs. In essence, the on-demand and individual consumption may be transformed to multicast/broadcast consumption e.g. when the communication system 1 resources, and in particular radio access network resources are scarce. An advantage is that bandwidth resources are saved, which is especially important when the radio access network is heavily loaded. It can be assumed that most users prefer to consume recommended content that is also multicast to other users over their request being rejected because of lack of radio resources.

A union of sets of information is obtained. For instance, two users that are in the same or nearby cells and have similar content preferences or same content pieces in their playlists, a union of their playlists is obtained. For the more general case of multiple users, the union can be produced faster if a set of users within the same cells are clustered according to content preferences. For instance, all users in a particular cell that prefer country music is equivalent to a first number of sets for which a union is to be found, while all users in the particular cell that prefer rock music is equivalent to a second number of sets for which a union is to be found. The service provider has the user preferences and information about playlists etc., while the operator of the wireless network 2 has information about which users are served by which radio access node. The union of sets of information can hence be made by the service provider when having received the information on users located within a certain area. Moreover the operator also has transition information about a UE 5a moving from one cell to another, and this information may also be provided to the service provider in order for the service provider to create these set unions in advance before the UE 5a moves into another cell, which may, for instance, be a congested area.

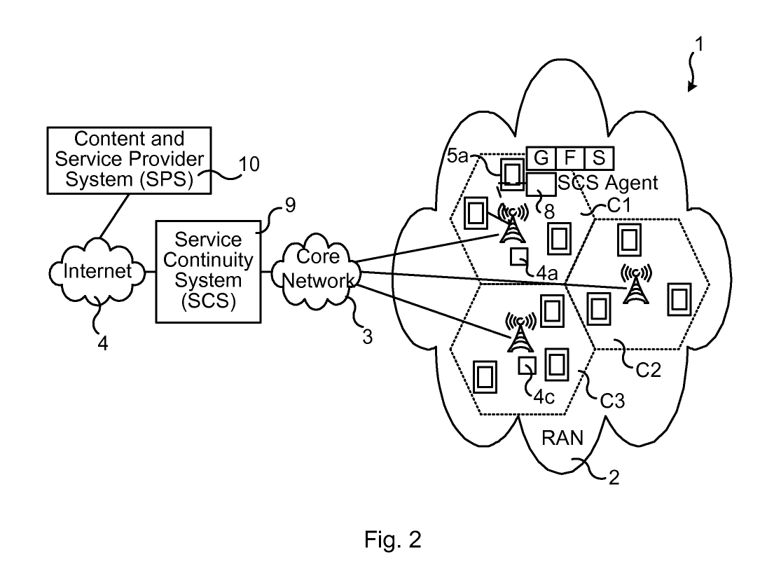

FIG. 2 shows the environment of FIG. 1, with some additional devices for implementing the described features and functions. In particular, a network node 9 also denoted Service Continuity System (SCS) node 9 in the following and an agent 8 provided in a UE 5a are provided. The network node 9 is introduced in the communication system 1, e.g. as a core network node or in an existing core network node a node of a RAN 2. The SCS node 9 may be a node owned and operated by the mobile network operator. In other embodiments, the SCS node 9 may e.g. be a server in “the cloud”, e.g. a server of Internet 4. The content consuming UE 5a has a corresponding part, an agent 8, also denoted SCS agent 8 herein.

For the purpose of the description, specific examples are used, e.g. audio content and provider of a music streaming service are used merely for the purpose of describing and exemplifying. It is noted that other services and service providers are also applicable. It is also assumed, for simplicity, that all UEs implement the methods by being equipped with a respective SCS Agent 8. It is noted that the methods may be implemented in the UE in other manners as well, e.g. in a distributed manner, wherein the SCS Agent 8 assembles the received content, while a LTE multicast feature receives at least some of the content.

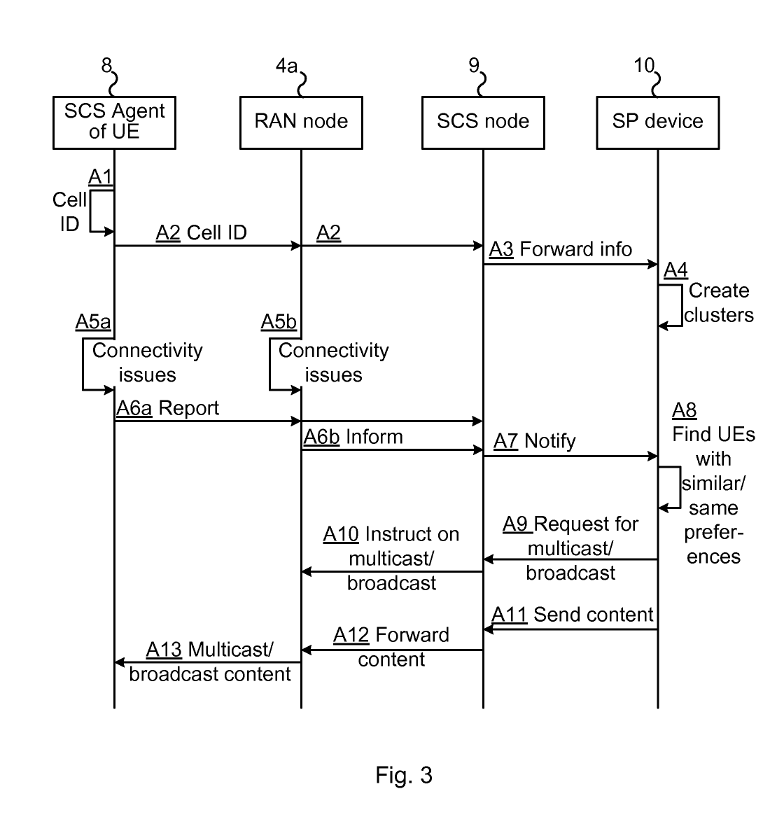

FIG. 3 is a sequence diagram showing various steps of various embodiments.

At arrow A1, the SCS Agent 8 of the UE keeps track of the cell ID of the UE periodically or on cell switch and sends (arrow A2) this information to the SCS node 9 via a RAN node 4a.

The SCS node 9 forwards (arrow A3) this information to the Service Provider (SP) 10.

The service provider 10 uses the received information about the UEs being in the same cell or nearby cell to further create (arrow A4) clusters of UEs that belong to users with similar content preferences or overlapping playlists.

At some point in time one or more UEs (e.g. first UE 5a) may have bad connectivity (arrows A5a, A5b for detection by the UE and RAN node 4a, respectively) due to cell congestion. The UEs may then report this connectivity issue (arrow Aha) to the SCS node 9 by means of their SCS Agents 8 (via the RAN node 4a). In other embodiments, the RAN 4a may inform (arrow A6b) the SCS node 9 about this connectivity issue.

The SCS node 9 then notifies (arrow A7) the service provider 10 about the congestion.

The service provider 10 uses the cluster information of similar preference UEs to determine (arrow A8) that a first UE 5a and second UE 5b should receive the same content regardless of the order of content pieces in the playlists currently playing in the first UE 5a and the second UE 5b. The service provider 10 may, for instance, send a recommendation to the second UE 5b about using same playlist as the first UE 5a, and second UE 5b may confirm (provide consent). Various different options and embodiments are described below.

The service provider 10 may send an instruction or request (arrow A9) to the SCS node 9 to start multicasting (or broadcasting), and provide the identities of the first and second UEs 5a, 5b and their updated playlists.

The SCS node 9, in turn, instructs (arrow A10) the RAN node 4a to start multicasting (or broadcasting) e.g. LTE multicasting content from the SCS node 9 to the first UE 5a and the second UE 5b. It is noted that before the RAN node 4a and the UE 5a can send or receive multicast/broadcast messages respectively, there may be a RAN specific protocol for setting up the radio receivers of the affected UEs for them to be able to receive broadcast/multicast transmissions. Such specific protocol is not shown in FIG. 3 but implied.

The SCS node 9 receives (arrow A11) content from the service provider 10 and forwards it (arrow A12) to the appropriate RAN node(s) 4a. The RAN node(s) 4a in turn forwards (arrow A13) the content to the affected UEs 5a, 5b. The SCS Agent 8 on the respective UE 5a, 5b receives the updated playlist and the content from the SCS node 9 and pushes it to the appropriate consumption application on the UE.

There are different conceivable embodiments of the playlist manipulation (arrow A4, A8), and a few are given below:

a) The service provider 10 may choose the content playlist of one particular UE e.g. the playlist of the first UE 5a as a playlist also for the second UE or vice versa.

b) The playlists of both UEs 5a, 5b may be rearranged to a common playlist which is the union of the two playlists. The restarting of playlists on the different UEs may be performed in different ways. The SCS Agent 8 may buffer the content in order to make sure that the content is totally consumed before a playlist switch can be performed. The amount of buffering may be dependent on prediction about a UE leaving a lightly loaded cell and soon entering a heavy loaded cell and/or the time for this exchange of messages between the SCS Agent 8, the SCS node 9 and the service provider 10 to enable the multicast operation. If buffering is not feasible the playlist could interrupt the current content consumption and start new content from the new playlist.

### Situation 2: Identical Content Consumption Close in Time

The second situation comprises content consumption without the control of user operating the UE 5a, 5b, 5c. Content is typically pushed to a UE application (also known as “app”) from content providers such as advertisement aggregators or any content fulfilling certain criteria by a specific content provider (e.g. content push based on user preferences on music genre, artist, etc.). The mechanism can be applied to either congested or non-congested networks. An incitement for a service provider to implement the described methods may be monetary e.g. the service provider 10 may obtain a discount from the operator of the wireless network for using the SCS node 9. Additional logic required in the SCS node 9 may comprise logic enabling the SCS node 9 to differentiate the same and different parts of the content to be pushed to the UEs, e.g. an advertisement may have the same Adobe Flash content but the price offer could be different for different users. The SCS node 9 may use the multicast mechanism to notify the SCS Agents 8 on the affected UEs 5a, 5b about the common content and separate radio bearers for the different pieces of information. The SCS Agent 8 combines the common and different parts to one content piece and delivers it to the UE application for displaying the content.

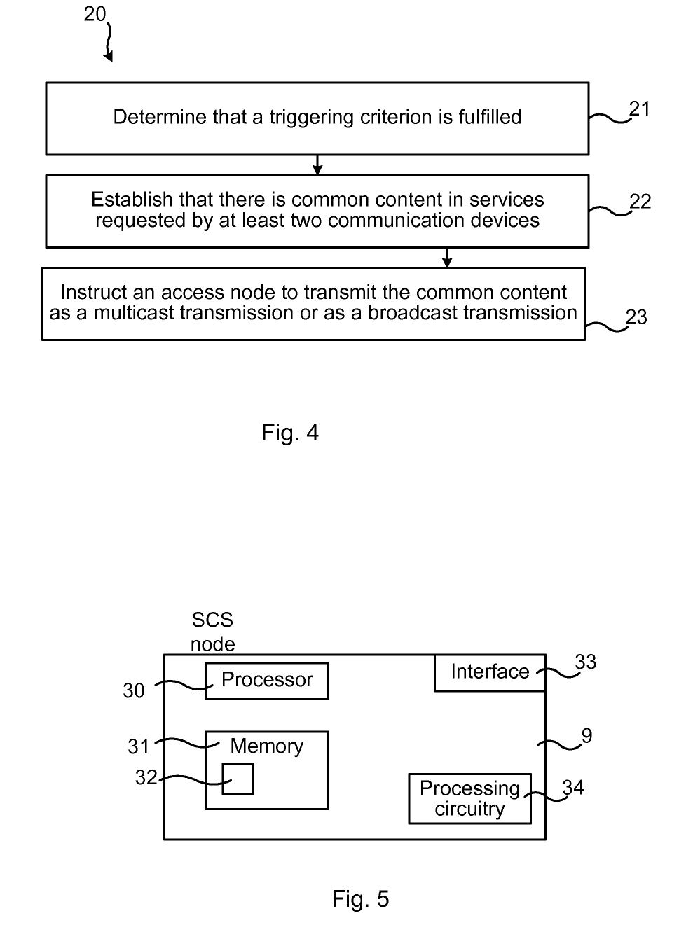

The various embodiments and features that have been described may be combined in many ways, examples of which are given in the following, with reference first to FIG. 4.

FIG. 4 illustrates a flow chart over steps of an embodiment of a method in a network node in accordance with the present teachings. The method 20 is performed in a network node 9 for content distribution in a communication system 1. The content may be part of a service such as, for instance, video or music. The network node 9 may be a node of the communication system 1, e.g. a core network node, operated by an operator of the communication system 1. In other embodiments, the network node 9 may be a node operated by a service provider and be, for instance, a server interconnected to a packet data network.

The method 20 comprises determining 21 a triggering criterion to be fulfilled. The criterion for triggering the method 20, i.e. the triggering criterion, may be set differently in view of different interests. For instance, in case the method 20 is implemented in a node of the communication system 1, e.g. in a core network, the triggering criterion may be related to e.g. load in the communication system 1 (e.g. RAN 2 thereof). If, for instance, all available radio resources in the RAN 2 are close to being fully used, then the method 20 may be triggered. An advantage is that radio resources can thereby be saved, since some content that are common for communication devices being served can be multicast or broadcast. As another example, the triggering criterion may comprise determining that there are communication devices 5a, 5b, 5c that are consuming the same service in the (geographical) proximity of each other.

The method 20 comprises establishing 22 that there is common content in services requested by at least two communication devices 5a, 5b, 5c. The fact that there is common content in services requested by two or more communication devices 5a, 5b, 5c can be established in different ways. When the method 20 is implemented in a node of the communication system 1, e.g. in the core network 3, the network node 9 may simply receive information about this from a network device 10 operated by a service provider. The service provider that is providing the service being requested may note that the same content is requested by two or more communication devices 5a, 5b, 5c that are located geographically within a certain range from each other, and notify the network node 9 about this. In other embodiments, the network node 9 may be able and allowed to detect this itself, e.g. via deep packet inspection. When the network node 9 is e.g. a core network node, such inspection may require the consent of the users (/owners) of the communication devices 5a, 5b, 5c.

The method 20 comprises instructing 23 an access node 4a, 4b, 4c of the communication system 1 to transmit the common content as one of: a multicast transmission and a broadcast transmission. In embodiments wherein the method 20 is implemented in a node of the communication system 1, e.g. in the core network 3, this may comprise instructing the access node 4a, 4b, 4c, e.g. a radio access node (eNB, EnodeB etc.) about multicast or broadcast to be done for the common content. In embodiments wherein the method 20 is implemented in a node owned by the service provider, the instructing 23 may comprise a request or suggesting that a broadcast or multicast is made for the common content. Such request or suggestion may be sent e.g. to a core network node, which in turn conveys this to the access node 4a, 4b, 4c.

As has been mentioned earlier, the method 20 provides several advantages. For instance, by means of the method 20 a more efficient resource usage is obtained. This is achieved by broadcasting or multicasting some content instead of transmitting the content in several individual streams to the communication devices 5a, 5b, 5c, and the same (radio) resources are used for two or more communication devices 5a, 5b, 5c. This is in contrast to known methods, wherein the same content flows through the communication system (e.g. through core network and transport network) in multiple copies. A broadcast service such as e.g. LTE Broadcast allows for efficient transmission in one part of the system, in particular over the radio interface. Service providers, providing the content, may also benefit from the method 20, since they do not need to serve the individual users separately. The whole path from the service provider, through, for instance, a core network, a transport network and a radio access network to the communication devices 5a, 5b can be optimized by means of the method 20.

In various embodiments, the method 20 comprises instructing the access node 4a, 4b, 4c to transmit non-common content parts of the services to the at least two communication devices 5a, 5b, 5c as a respective unicast transmission. The content of the service may be divided into a first part that comprises content common to two or more communication devices 5a, 5b, 5c, and a second part that comprises content that is specific (non-common) for the respective communication device 5a, 5b, 5c. The first part is broadcast or multicast, and the second part may be unicast in a respective unicast transmission to the communication devices 5a, 5b, 5c.

In various embodiments, the method 20 comprises providing instructions to the access node 4a, 4b, 4c for conveyance to the at least two communication devices 5a, 5b, 5c, the instructions indicating how to assemble a multicast or broadcast transmission and a unicast transmission into the requested service. As a first example, the application running in the communication devices 5a, 5b, 5c may open two channels, one for unicast transmission and one for listening to multicast/broadcast transmission. The first channel may be used to convey user specific content, while the second one may be used to convey common content. Another example, the multicast/broadcast data may contain a specific field indicating that it is common content instead of user specific content. As a particular illustrative example, a video with subtitles can be mentioned. While two users would like to watch the same video the subtitle language could be different based on user preferences. The video in such case is the common part to the transmitted in multicast/broadcast and the subtitles in different languages are the individual parts to be transmitted in unicast. The common content is the video file which can be annotated with a unique identification (ID) ID1 and the two subtitle files may be distinct content for distinct users and have Identifiers ID2 and ID3, respectively. In a first UE of a first user the assembly instructions may state “assemble(ID1, ID2)” while in a second UE of a second user the assembly instructions may state “assemble(ID1, ID3)”. A function “Assemble(BroadcastContentID, UnicastContentID)” may be implemented for each specific application. Hence, both multicast/broadcast data and unicast data may contain a unique identification (ID) or a type which can be used to link two types of data. For example, the application running in the communication devices 5a, 5b, 5c may define a placeholder for unicast data with type “activities”, and a placeholder for multicast/broadcast data with type “ads”, and then all data marked as “activities” will be fed into the first placeholder and all data marked as “ads” will be fed into the second one. From this, it is clear that the assembling of multicast and broadcast data may be application specific.

In various embodiments, the establishing 22 comprises receiving information from a network device 10 about the at least two communication devices 5a, 5b, 5c having common content in their requested services. The network device 10 may be a device operated by the service provider, and has information about all services that are being requested. The service provider may then in a straight forward manner recognize that the same content is requested by different communication devices 5a, 5b, 5c, e.g. by performing a comparison.

In various embodiments, the method 20 comprises receiving from a respective agent 8 of one or more of the communication devices 5a, 5b, 5c location information on location of the communication device 5a, 5b, 5c and conveying the information to a network device 10. A user of a communication device 5a, 5b, 5c may have an agreement with a service provider that the latter is allowed to obtain and use location information relating to the communication device 5a, 5b, 5c. As described earlier, such agent 8 may, for instance, comprise a software agent, e.g. a computer program acting for the communication device 5a, 5b, 5c.

In various embodiments, the determining 21 comprises one of: determining a traffic load parameter in the communication system 1 to meet a triggering threshold, receiving an instruction from a service provider, and receiving an indication from at least one of the communication devices 5a, 5b, 5c on connectivity not fulfilling a requirement.

FIG. 5 illustrates schematically a network node 9 and means for implementing embodiments of the method in accordance with the present teachings.

The network node 9 comprises a processor 30 comprising any combination of one or more of a central processing unit (CPU), multiprocessor, microcontroller, digital signal processor (DSP), application specific integrated circuit etc. capable of executing software instructions stored in a memory 31 which can thus be a computer program product. The processor 30 can be configured to execute any of the various embodiments of the method 20 for instance as described in relation to FIG. 4.

The memory 31 of the network node 9 can be any combination of read and write memory (RAM) and read only memory (ROM), Flash memory, magnetic tape, Compact Disc (CD)-ROM, digital versatile disc (DVD), Blu-ray disc etc. The memory 31 may also comprise persistent storage, which, for example, can be any single one or combination of magnetic memory, optical memory, solid state memory or even remotely mounted memory.

The network node 9 comprises an interface 33 for communication with other devices. The interface 33 may, for instance, comprise a protocol stack, for communication with other devices.

The network node 9 may comprise additional processing circuitry, schematically indicated at reference numerals 34 for implementing the various embodiments according to the present teachings.

A network node 9 is provided for content distribution in a communication system 1. The network node 9 is configured to:
determine a triggering criterion to be fulfilled,
establish that there is common content in services requested by at least two communication devices 5a, 5b, 5c, and
instruct an access node 4a, 4b, 4c of the communication system 1 to transmit the common content as one of: a multicast transmission and a broadcast transmission.

The network node 9 may be configured to perform the above steps e.g. by comprising one or more processors 30 and memory 31, the memory 31 containing instructions executable by the processor 30, whereby the network node 9 is operative to perform the steps. That is, in an embodiment, a network node 9 is provided for content distribution in a communication system 1, the network node 9 comprising one or more processors 30 and memory 31, the memory 31 containing instructions executable by the processor 30, whereby the network node 9 is operative to: determine a triggering criterion to be fulfilled; establish that there is common content in services requested by at least two communication devices 5a, 5b, 5c, and instruct an access node 4a, 4b, 4c of the communication system 1 to transmit the common content as one of: a multicast transmission and a broadcast transmission.

In an embodiment, the network node 9 is configured to instruct the access node 4a, 4b, 4c to transmit non-common content parts of the services to the at least two communication devices 5a, 5b, 5c as a respective unicast transmission.

In various embodiments, the network node 9 is configured to provide instructions to the access node 4a, 4b, 4c for conveyance to the at least two communication devices 5a, 5b, 5c, the instructions indicating how to assemble a multicast or broadcast transmission and a unicast transmission into the requested service.

In various embodiments, the network node 9 is configured to establish by receiving information from a network device 10 about the at least two communication devices 5a, 5b, 5c having common content in their requested services.

In various embodiments, the network node 9 is configured to receive from a respective agent 8 of one or more of the communication devices 5a, 5b, 5c location information on location of the communication device 5a, 5b, 5c and configured to convey the information to a network device 10.

In various embodiments, the network node 9 is configured to determine by one of: determining a traffic load parameter in the communication system 1 to meet a triggering threshold, receiving an instruction from a service provider, and receiving an indication from at least one of the communication devices 5a, 5b, 5c on connectivity not fulfilling a requirement.

The present teachings also encompass a computer program 32 for a network node 9 for content distribution in a communication system 1. The computer program 32 comprises computer program code, which, when executed on at least one processor on the network node 9, causes the network node 9 to perform the method 20 according to any of the described embodiments.

The present teachings also encompass computer program products 31 for a network node 9. The computer program product 31 comprises a computer program 32 for implementing the embodiments of the methods as described, and a computer readable means on which the computer program 32 is stored. The computer program product, or the memory, thus comprises instructions executable by the processor 30. Such instructions may be comprised in a computer program, or in one or more software modules or function modules. The computer program product 31 may, as mentioned earlier, be any combination of random access memory (RAM) or read only memory (ROM), Flash memory, magnetic tape, Compact Disc (CD)-ROM, digital versatile disc (DVD), Blu-ray disc etc.

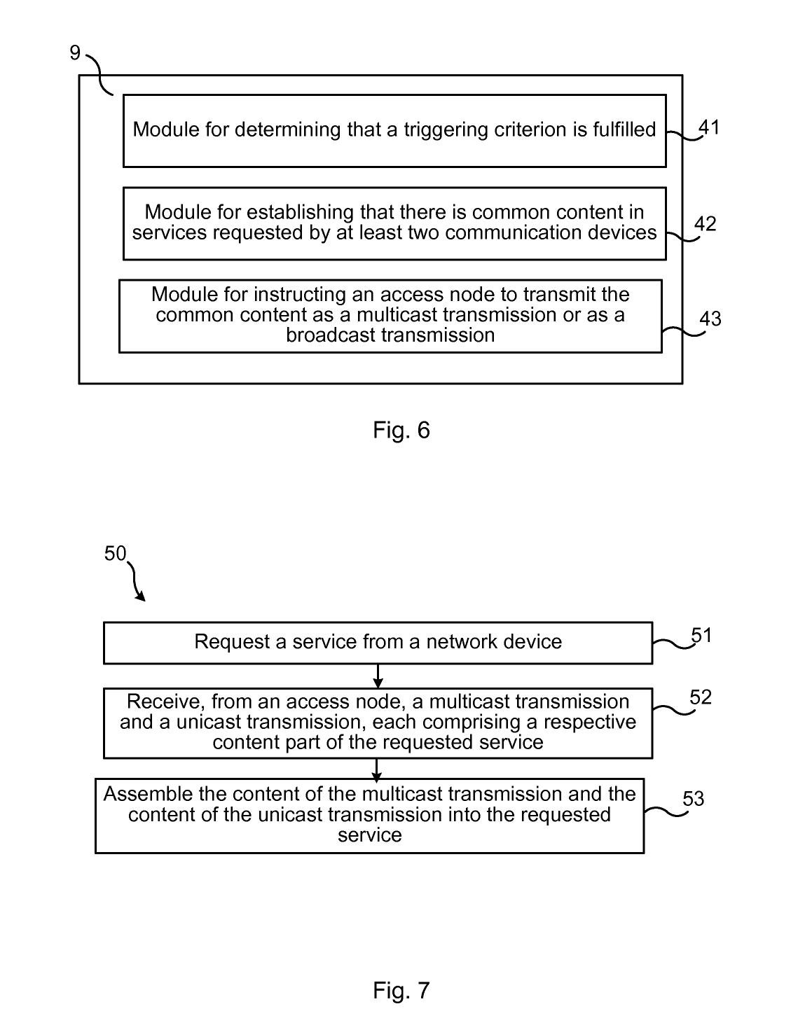

FIG. 6 illustrates a network node comprising function modules/software modules for implementing embodiments of the present teachings. The function modules can be implemented using software instructions such as computer program executing in a processor and/or using hardware, such as application specific integrated circuits (ASICs), field programmable gate arrays, discrete logical components etc., and any combination thereof. Processing circuitry may be provided, which may be adaptable and in particular adapted to perform any of the steps of the method 20 that has been described.

A network node is provided for content distribution in a communication system. The network node comprises a first module 41 for determining a triggering criterion to be fulfilled. Such first module 41 may for instance comprise processing circuitry adapted to determine that a triggering criterion is fulfilled.

The network node comprises a second module 42 for establishing that there is common content in services requested by at least two communication devices. Such second module 42 may for instance comprise processing circuitry adapted to establish presence of common content in services requested by two or more communication devices.

The network node comprises a third module 43 for instructing an access node of the communication system to transmit the common content as one of: a multicast transmission and a broadcast transmission. Such third module 43 may for instance comprise processing circuitry adapted to instruct an access node, and/or an interface for sending instructions.

It is noted that one or more of the modules 41, 42, 43 may be replaced by units.

FIG. 7 illustrates a flow chart over steps of an embodiment of a method in a communication device in accordance with the present teachings. The method 50 may be performed in a communication device 5a, 5b, 5c for content reception in a communication system 1. The method 50 comprises requesting 51 a service from a network device 10. The network device 10 may in essence be any type of service provider supporting the functions and features described herein, e.g. being able to cluster users based on their preferences.

The method 50 comprises receiving 52, from an access node 4a, 4b, 4c of the communication system 1, a multicast transmission and a unicast transmission, each comprising a respective content part of the requested service.

The method 50 comprises assembling 53 the content of the multicast transmission and the content of the unicast transmission into the requested service. For implementing method 50 in the communication device 5a, 5b, 5c, it may comprise the described SCS Agent 8, i.e. the SCS agent may be configured to perform the steps.

Also this method 50 provides a number of advantages. For instance, a user of the communication device 5a, 5b, 5c is provided with a requested service even in the case that the radio access network providing the wireless communication is highly loaded. The requested service may, in some cases, have been slightly modified. For instance, in a case wherein a playlist is streamed by the user, another user may be requesting a playlist with similar content. Instead of one or both users loosing their connection to the service provider due to congestion in e.g. the radio access network, they get the requested music, but wherein each user might get their music possibly in another order than according to their own initial playlist.

In various embodiments, the method 50 comprises receiving, from the access node 4a, 4b, 4c, instructions for the assembling 53. As described earlier, e.g. in relation to FIG. 4 and method 20, specific fields can be used, indicating that it is common content instead of user specific content. The communication device 5a, 5b, 5c may then assemble the content based on the instructions.

In various embodiments, the method 50 comprises sending, to the access node 4a, 4b, 4c, location information on location of the communication device 5a, 5b, 5c for conveyance of the information to the network device 10. The location information may, for instance, comprise cell identity (as has been described earlier).

In various embodiments, the method 50 comprises sending, to the access node 4a, 4b, 4c, an indication on connectivity not fulfilling a requirement. This may comprise sending some type of radio quality measure on the wireless link, e.g. a channel quality indicator (CQI) or reference signal received power (RSRP) or channel state information (CSI) etc. being below some threshold value.

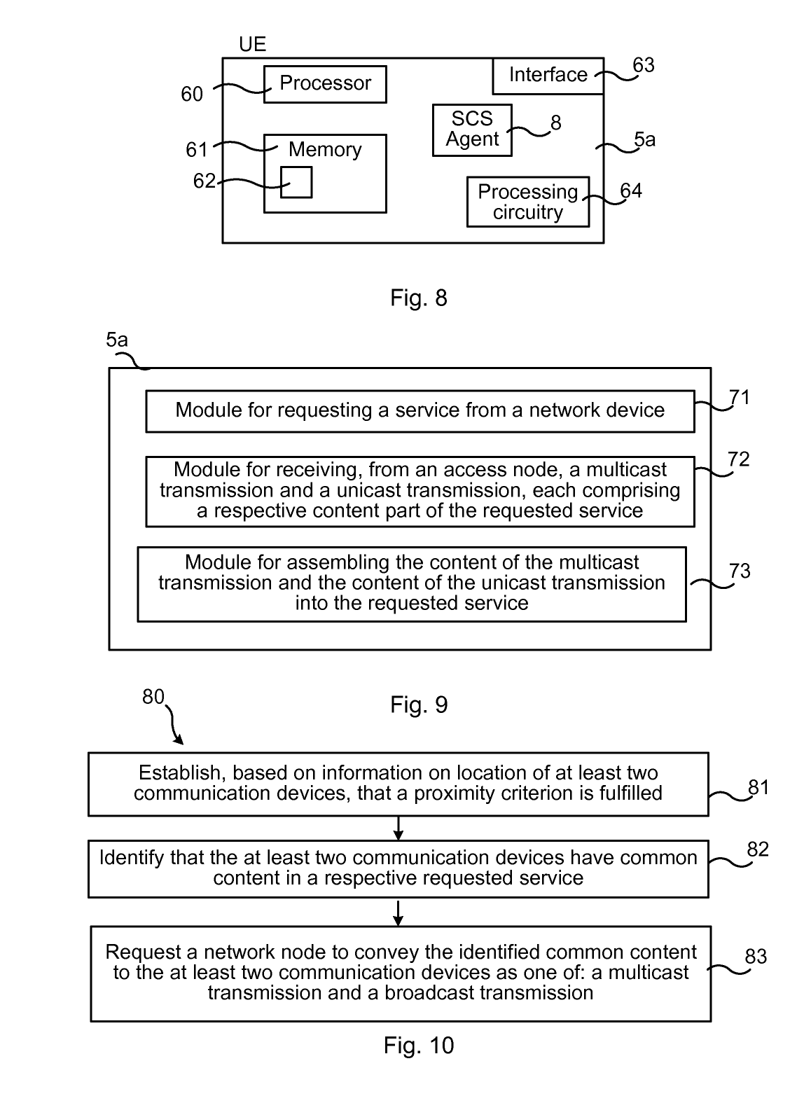

FIG. 8 illustrates schematically a communication device and means for implementing embodiments of the method in accordance with the present teachings.

The communication device 5a comprises a processor 60 comprising any combination of one or more of a central processing unit (CPU), multiprocessor, microcontroller, digital signal processor (DSP), application specific integrated circuit etc. capable of executing software instructions stored in a memory 61 which can thus be a computer program product. The processor 60 can be configured to execute any of the various embodiments of the method 50 for instance as described in relation to FIG. 7.

The memory 61 of the communication device 5a can be any combination of read and write memory (RAM) and read only memory (ROM), Flash memory, magnetic tape, Compact Disc (CD)-ROM, digital versatile disc (DVD), Blu-ray disc etc. The memory 61 may also comprise persistent storage, which, for example, can be any single one or combination of magnetic memory, optical memory, solid state memory or even remotely mounted memory.

The communication device 5a comprises an interface 63 for communication with other devices. The interface 63 may, for instance, comprise a protocol stack, for communication with radio access nodes 4a, 4b, 4c.

The communication device 5a comprises an SCS Agent 8, described earlier, for implementing the various embodiments. For instance, the SCS Agent 8 may keep track of the cell ID of the cell in which the UE 5a is currently residing and report this to the SCS node 9 (via a radio access node 4a). The SCS Agent 8 may also assemble the received content according to the received instructions.

The communication device 5a may comprise additional processing circuitry, schematically indicated at reference numerals 64 for implementing the various embodiments according to the present teachings.

A communication device 5a, 5b, 5c is provided for content reception in a communication system 1. The communication device 5a, 5b, 5c is configured to:
request a service from a network device 10,
receive, from an access node 4a, 4b, 4c of the communication system 1, a multicast transmission and a unicast transmission, each comprising a respective content part of the requested service, and
assemble the content of the multicast transmission and the content of the unicast transmission into the requested service.

The communication device 5a, 5b, 5c may be configured to perform the above steps e.g. by comprising one or more processors 60 and memory 61, the memory 61 containing instructions executable by the processor 60, whereby the communication device 5a, 5b, 5c is operative to perform the steps. That is, in an embodiment, a communication device 5a, 5b, 5c is provided for content reception in a communication system 1, the communication device 5a, 5b, 5c comprising one or more processors 60 and memory 61, the memory 61 containing instructions executable by the processor 60, whereby the communication device 5a, 5b, 5c is operative to: request a service from a network device 10; receive, from an access node 4a, 4b, 4c of the communication system 1, a multicast transmission and a unicast transmission, each comprising a respective content part of the requested service; and assemble the content of the multicast transmission and the content of the unicast transmission into the requested service.

In various embodiments, the communication device 5a, 5b, 5c is configured to receive, from the access node 4a, 4b, 4c, instructions for the assembling 53.

In various embodiments, the communication device 5a, 5b, 5c is configured to send, to the access node 4a, 4b, 4c, location information on location of the communication device 5a, 5b, 5c for conveyance of the information to the network device 10.

In various embodiments, the communication device 5a, 5b, 5c is configured to send, to the access node 4a, 4b, 4c, an indication on connectivity not fulfilling a requirement.

The present teachings also encompass a computer program 62 for a communication device 5a for content reception in a communication system 1. The computer program 62 comprises computer program code, which, when executed on at least one processor on the communication device 5a, causes the communication device 5a to perform the method 50 according to any of the described embodiments.

The present teachings also encompass computer program products 61 for a communication device 5a. The computer program product 61 comprises a computer program 62 for implementing the embodiments of the methods as described, and a computer readable means on which the computer program 62 is stored. The computer program product, or the memory, thus comprises instructions executable by the processor 60. Such instructions may be comprised in a computer program, or in one or more software modules or function modules. The computer program product 61 may, as mentioned earlier, be any combination of random access memory (RAM) or read only memory (ROM), Flash memory, magnetic tape, Compact Disc (CD)-ROM, digital versatile disc (DVD), Blu-ray disc etc.

FIG. 9 illustrates a communication device comprising function modules/software modules for implementing embodiments of the present teachings. The function modules can be implemented using software instructions such as computer program executing in a processor and/or using hardware, such as application specific integrated circuits (ASICs), field programmable gate arrays, discrete logical components etc., and any combination thereof. Processing circuitry may be provided, which may be adaptable and in particular adapted to perform any of the steps of the method 50 that has been described.

A communication device is provided for content reception in a communication system. The communication device comprises a first module 71 for requesting a service from a network device. Such first module 71 may for instance comprise processing circuitry adapted to request a service e.g. through an interface (e.g. interface 63 described with reference to FIG. 8).

The communication device comprises a second module 72 for receiving, from an access node, a multicast transmission and a unicast transmission, each comprising a respective content part of the requested service. Such second module 72 may for instance comprise processing circuitry adapted to receive such transmissions e.g. through an interface (e.g. interface 63 described with reference to FIG. 8).

The communication device comprises a third module 73 for assembling the content of the multicast transmission and the content of the unicast transmission into the requested service. Such third module 73 may for instance comprise processing circuitry adapted to perform such assembling.

It is noted that one or more of the modules 71, 72, 73 may be replaced by units.

FIG. 10 illustrates a flow chart over steps of an embodiment of a method in a network device in accordance with the present teachings. The method 80 may be performed in a network device 10 for content distribution in a communication system 1, e.g. a network device 10 in a content and service provider system (see e.g. FIG. 2), which can be part of the communication system 1. The method 80 comprises establishing 81, based on information on location of at least two communication devices 5a, 5b, 5c, that a proximity criterion is fulfilled. This establishing may comprise receiving location information from the communication devices 5a, 5b, 5c, e.g. using Global Positioning System (GPS), and in particular as part of the application in the communication device used by the user of the communication device for receiving the service. However, in addition the network device 10 may need e.g. a cell identity (cell ID) from the communication device (or by SCS node 9) in order to know that the two or more communication devices are served by same or neighboring radio access nodes. The establishing of fulfillment of the proximity criterion can then be made based on e.g. GPS information and/or cell ID.

The method 80 comprises identifying 82 that the at least two communication devices 5a, 5b, 5c have common content in a respective requested service. Since the service provider has the preferences of the users, the network device 10 can be provided with (or have stored therein) the user preferences and based on this find their common content.

The method 80 comprises requesting 83 a network node 9 of the communication system 1 to convey the identified common content to the at least two communication devices 5a, 5b, 5c as one of: a multicast transmission and a broadcast transmission. As mentioned earlier, the service provider may be given a monetary incitement to implement the method 80, and thereby also obtain higher user satisfaction.

In various embodiments, the method 80 comprises requesting the network node 9 to convey non-common parts of the respective requested service to the at least two communication devices 5a, 5b, 5c as a respective unicast transmission.

In various embodiments, the establishing 81 comprises receiving, from the network node 9, information on the at least two communication devices 5a, 5b, 5c being within same or neighboring service areas C1, C2, C3 of access nodes 4a, 4b, 4c of the communication system 1 and determining that the proximity criterion is fulfilled based on this information.

In various embodiments, the identifying 82 is based on one of: respective service preferences obtained for each of the at least two communication devices 5a, 5b, 5c, and service preferences for one of the at least two communication devices 5a, 5b, 5c.

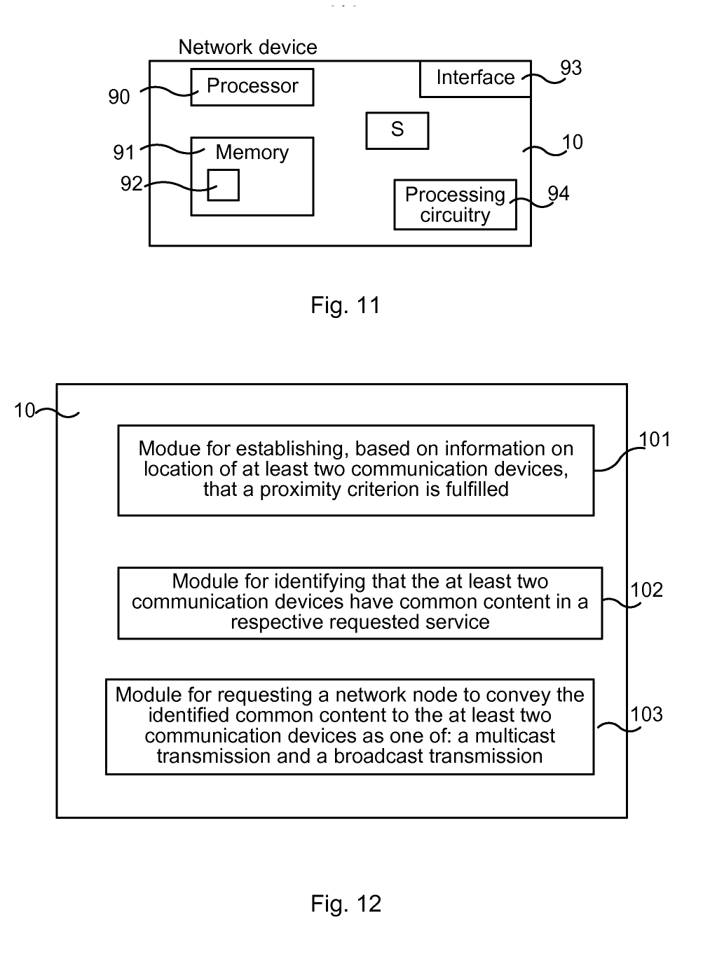

FIG. 11 illustrates schematically a network device and means for implementing embodiments of the method in accordance with the present teachings.

The network device 10 comprises a processor 90 comprising any combination of one or more of a central processing unit (CPU), multiprocessor, microcontroller, digital signal processor (DSP), application specific integrated circuit etc. capable of executing software instructions stored in a memory 91 which can thus be a computer program product. The processor 90 can be configured to execute any of the various embodiments of the method 80 for instance as described in relation to FIG. 10.

The memory 91 of the network device 10 can be any combination of read and write memory (RAM) and read only memory (ROM), Flash memory, magnetic tape, Compact Disc (CD)-ROM, digital versatile disc (DVD), Blu-ray disc etc. The memory 91 may also comprise persistent storage, which, for example, can be any single one or combination of magnetic memory, optical memory, solid state memory or even remotely mounted memory.

The network device 10 comprises an interface 93 for communication with other devices. The interface 93 may, for instance, comprise a protocol stack, for communication with a core network node 9.

The network device 10 may comprise various applications S as have been described earlier, or have access to them. For instance, the network device 10 may comprise processing circuitry for providing a communication device access to a service such as a music streaming service.

The network device 10 may comprise additional processing circuitry, schematically indicated at reference numerals 94 for implementing the various embodiments according to the present teachings.

A network device 10 is provided for content distribution in a communication system 1. The network device 10 is configured to:
establish, based on information on location of at least two communication devices 5a, 5b, 5c, that a proximity criterion is fulfilled,
identify that the at least two communication devices 5a, 5b, 5c have common content in a respective requested service, and
request a network node 9 of the communication system 1 to convey the identified common content to the at least two communication devices 5a, 5b, 5c as one of: a multicast transmission and a broadcast transmission.

The network device 10 may be configured to perform the above steps e.g. by comprising one or more processors 90 and memory 91, the memory 91 containing instructions executable by the processor 90, whereby the network device 10 is operative to perform the steps. That is, in an embodiment, a network device 10 is provided for content distribution in a communication system 1, the network device 10 comprising one or more processors 90 and memory 91, the memory 91 containing instructions executable by the processor 90, whereby the network device 10 is operative to: establish, based on information on location of at least two communication devices 5a, 5b, 5c, that a proximity criterion is fulfilled; identify that the at least two communication devices 5a, 5b, 5c have common content in a respective requested service; and request a network node 9 of the communication system 1 to convey the identified common content to the at least two communication devices 5a, 5b, 5c as one of: a multicast transmission and a broadcast transmission.

In various embodiments, the network device 10 is configured to request the network node 9 to convey non-common parts of the respective requested service to the at least two communication devices 5a, 5b, 5c as a respective unicast transmission.

In various embodiments, the network device 10 is configured to establish by receiving, from the network node 9, information on the at least two communication devices 5a, 5b, 5c being within same or neighboring service areas C1, C2, C3 of access nodes 4a, 4b, 4c of the communication system 1 and configured to determine that the proximity criterion is fulfilled based on this information.

In various embodiments, the network device 10 is configured to identify based on one of: respective service preferences obtained for each of the at least two communication devices 5a, 5b, 5c, and service preferences for one of the at least two communication devices 5a, 5b, 5c.

The present teachings also encompass a computer program 92 for a network device for content reception in a communication system 1. The computer program 92 comprises computer program code, which, when executed on at least one processor on the network device, causes the network device to perform the method 80 according to any of the described embodiments.

The present teachings also encompass computer program products 91 for a network device. The computer program product 91 comprises a computer program 92 for implementing the embodiments of the methods as described, and a computer readable means on which the computer program 92 is stored. The computer program product, or the memory, thus comprises instructions executable by the processor 90. Such instructions may be comprised in a computer program, or in one or more software modules or function modules. The computer program product 91 may, as mentioned earlier, be any combination of random access memory (RAM) or read only memory (ROM), Flash memory, magnetic tape, Compact Disc (CD)-ROM, digital versatile disc (DVD), Blu-ray disc etc.

FIG. 12 illustrates a network device comprising function modules/software modules for implementing embodiments of the present teachings. The function modules can be implemented using software instructions such as computer program executing in a processor and/or using hardware, such as application specific integrated circuits (ASICs), field programmable gate arrays, discrete logical components etc., and any combination thereof. Processing circuitry may be provided, which may be adaptable and in particular adapted to perform any of the steps of the method 80 that has been described.

A network device is provided for content distribution in a communication system. The network device comprises a first module 101 for establishing, based on information on location of at least two communication devices, that a proximity criterion is fulfilled. Such first module 101 may for instance comprise processing circuitry adapted to use location information as input and to establish based thereon that a proximity criterion is fulfilled.

The network device comprises a second module 102 for identifying that the at least two communication devices have common content in a respective requested service. Such second module 102 may for instance comprise processing circuitry adapted to identify that the at least two communication devices have common content in a respective requested service (e.g. processing circuitry 94 described with reference to figure ii).

The network device comprises a third module 103 for requesting a network node of the communication system to convey the identified common content to the at least two communication devices as one of: a multicast transmission and a broadcast transmission.

Such third module 103 may for instance comprise processing circuitry adapted to perform such requesting (e.g. processing circuitry 94 described with reference to figure ii).

It is noted that one or more of the modules 101, 102, 103 may be replaced by units.

In summary, a core of the described methods lies in the service provider being made aware of the existence of multiple content consumers within a cell or nearby cells and the awareness of the subset of these users that consume the same or similar content at the same or close time instants. An assisting node (SCS node 9) helps the service provider to convert individual content consumption sessions to one or few common content consumption sessions so that in the face of e.g. cell congestion the service users can consume content that fulfills their preferences instead of being faced with complete service denial. In other words, as a core idea the present teachings provide mechanisms for service continuity in the face of cell congestion.

The invention has mainly been described herein with reference to a few embodiments. However, as is appreciated by a person skilled in the art, other embodiments than the particular ones disclosed herein are equally possible within the scope of the invention, as defined by the appended patent claims.

1-34. (canceled)

35. A method performed in a network node for content distribution in a communication system, the method comprising:
determining a triggering criterion to be fulfilled;
establishing that there is common content in services requested by at least two communication devices; and
instructing an access node of the communication system to transmit the common content as one of: a multicast transmission and a broadcast transmission.

36. The method as claimed in claim 35, further comprising instructing the access node to transmit non-common content parts of the services to the at least two communication devices as a respective unicast transmission.

37. The method as claimed in claim 35, further comprising providing instructions to the access node for conveyance to the at least two communication devices, the instructions indicating how to assemble a multicast or broadcast transmission and a unicast transmission into the requested service.

38. The method as claimed in claim 35, wherein the establishing comprises receiving information from a network device about the at least two communication devices having common content in their requested services.

39. The method as claimed in claim 35, further comprising receiving, from a respective agent of a given one of the at least two communication devices, location information on a location of the given communication device and conveying the location information to a network device.

40. The method as claimed in claim 35, wherein the determining comprises one of: determining a traffic load parameter in the communication system to meet a triggering threshold; receiving an instruction from a service provider; and receiving an indication from at least one of the communication devices on connectivity not fulfilling a requirement.

41. A network node configured for content distribution in a communication system, the network node comprising:
processing circuitry; and
a memory comprising instructions executable by the processing circuitry, whereby the network node is operable to:
determine a triggering criterion to be fulfilled;
establish that there is common content in services requested by at least two communication devices; and
instruct an access node of the communication system to transmit the common content as one of: a multicast transmission and a broadcast transmission.

42. The network node as claimed in claim 41, wherein the memory comprises instructions whereby the network node is operable to instruct the access node to transmit non-common content parts of the services to the at least two communication devices as a respective unicast transmission.

43. The network node as claimed in claim 41, wherein the memory comprises instructions whereby the network node is operable to provide instructions to the access node for conveyance to the at least two communication devices, the instructions indicating how to assemble a multicast or broadcast transmission and a unicast transmission into the requested service.

44. The network node as claimed in claim 41, wherein the memory comprises instructions whereby the network node is operable to establish that there is common content by receiving information from a network device about the at least two communication devices having common content in their requested services.

45. The network node as claimed in claim 41, wherein the memory comprises instructions whereby the network node is operable to receive, from a respective agent of a given one of the at least two communication devices, location information on a location of the given communication device and convey the location information to a network device.

46. The network node as claimed in claim 41, wherein the memory comprises instructions whereby the network node is operable to determine the triggering criterion to be fulfilled by one of: determining a traffic load parameter in the communication system to meet a triggering threshold; receiving an instruction from a service provider; and receiving an indication from at least one of the communication devices on connectivity not fulfilling a requirement.

47. A communication device configured for content reception in a communication system, the communication device comprising:
processing circuitry; and
a memory comprising instructions executable by the processing circuitry, whereby the communication device is operable to:
request a service from a network device;
receive, from an access node of the communication system, a multicast transmission and a unicast transmission, each comprising a respective content part of the requested service; and
assemble the content of the multicast transmission and the content of the unicast transmission into the requested service.

48. The communication device as claimed in claim 47, wherein the memory comprises instructions whereby the communication device is operable to receive, from the access node, instructions for the assembling.

49. The communication device as claimed in claim 47, wherein the memory comprises instructions whereby the communication device is operable to send, to the access node, location information on a location of the communication device for conveyance of the information to the network device.

50. The communication device as claimed in claim 47, wherein the memory comprises instructions whereby the network node is operable to send, to the access node, an indication on connectivity not fulfilling a requirement.

51. A network device configured for content distribution in a communication system, the network device comprising:
processing circuitry; and
a memory comprising instructions executable by the processing circuitry, whereby the network device is operable to:
establish, based on information on locations of at least two communication devices, that a proximity criterion is fulfilled;
identify that the at least two communication devices have common content in a respective requested service; and
request a network node of the communication system to convey the identified common content to the at least two communication devices as one of: a multicast transmission and a broadcast transmission.

52. The network device as claimed in claim 51, wherein the memory comprises instructions whereby the network device is operable to request the network node to convey non-common parts of the respective requested service to the at least two communication devices as a respective unicast transmission.

53. The network device as claimed in claim 51, wherein the memory comprises instructions whereby the network device is operable to establish that the proximity criterion is fulfilled by receiving, from the network node, information on the at least two communication devices being within the same or neighboring service areas of access nodes of the communication system and determining that the proximity criterion is fulfilled based on this information.

54. The network device as claimed in claim 51, wherein the memory comprises instructions whereby the network device is operable to identify based on one of: respective service preferences obtained for each of the at least two communication devices; and service preferences for one of the at least two communication devices.
